(19) United States
(12) Patent Application Publication
(10) Pub. No.: US 2026/0140978 A1
(43) Pub. Date: May 21, 2026

(54) DETERMINING IMPROVED PARAMETER VALUES FOR OPERATING A LARGE LANGUAGE MODEL USING MACHINE LEARNING

(71) Applicant: International Business Machines Corporation, Armonk, NY (US)

(72) Inventors: Lukasz CMIELOWSKI, Kraków (PL); Daniel RYSZKA, Kraków (PL); Jakub WALASZCZYK, Czeladz (PL); Dorota LACZAK, Mielec (PL)

(21) Appl. No.: 19/069,130

(22) Filed: Mar. 3, 2025

(30) Foreign Application Priority Data
Nov. 20, 2024 (GB) GB2417043.3

(51) Int. Cl. G06F 16/3329; G06F 16/334

(52) U.S. Cl. CPC G06F 16/33295; G06F 16/3347

(57) ABSTRACT

The present disclosure relates to a method for determining improved values of parameters for operating a Large-Language-Model, LLM, comprising: generating chunks of documents and input content dependent on the chunks according to several different modes, wherein the respective mode is specified by a respective set of values of the parameters; generating a prompt for the LLM dependent on the input content and a respective question; providing the prompt as an input to the LLM and receiving a respective provisional answer in response from the LLM; and performing a comparison between the provisional answer and a target answer resulting in a score for the respective question; training a machine-learning module using the sets of values of the parameters and the scores for the questions as training data; and performing a search for the improved values of the parameters using the trained ML-module.

### BACKGROUND

The present invention relates to the field of digital computer systems, and more specifically, to a method for determining an improved set of values of parameters for operating a Large Language Model (LLM).

Using an LLM for question and answer tasks is getting more common. It is possible to provide additional input content in a prompt for the LLM, in addition to a question of interest. There are many possible variations for how the additional input content may be retrieved, for example, using a retrieval-augmented generation method (RAG), and how the LLM may be instructed. Therefore, it may be time consuming and may require too many computational resources to find an optimal setting of values of parameters for prescribing how the additional input content may be retrieved and/or for prescribing an operation mode of the LLM.

### SUMMARY

Various embodiments provide a method for determining an improved set of values of parameters for operating an LLM, computer program product, and computer system, as described by the subject matter of the independent claims. Advantageous embodiments are described in the dependent claims. Embodiments of the present invention can be freely combined with each other if they are not mutually exclusive.

In one aspect, the invention relates to a method for determining an improved set of values of parameters for operating a Large-Language-Model, LLM, dependent on a set of documents. The method comprises loading a set of questions and answers. The respective answer corresponds to one of the questions. The questions relate to a content provided by the set of documents. The method further comprises performing repetitions. The performing of the repetitions comprises using a respective mode. Furthermore, the performing of the repetitions comprises generating a respective set of chunks of the documents dependent on the set of documents and generating an input content dependent on the set of chunks of the documents. The generating of the set of chunks and the input content is performed according to the respective mode. The respective mode differs for the respective repetition and is specified by a respective set of values of the parameters. The value of the respective parameter specifies how the generating of the set of chunks or the input content is performed.

Furthermore, the performing of the repetitions comprises generating a prompt for the LLM dependent on the input content and a question of the questions.

Furthermore, the performing of the repetitions comprises providing the prompt as an input to the LLM and receiving a respective provisional answer in response from the LLM.

Furthermore, the performing of the repetitions comprises performing a comparison between the respective provisional answer and the respective answer corresponding to that question dependent on the prompt that was generated resulting in a score for the question.

The method further comprises generating a respective overall score for the respective mode dependent on the resulting scores for the questions and generating training data sets comprising, for the modes, the respective set of values of the parameters specifying the respective mode and the respective overall score.

The method further comprises training a machine-learning module, ML-module, using the sets of values of the parameters of the training data sets as input and the overall scores of the training data sets as target output of the ML-module.

The method further comprises performing a search for the improved set of values of the parameters using the trained ML-module, wherein inputting the improved set of values of the parameters into the trained ML-module results in an improved score greater than the greatest overall score of the training data sets.

In one aspect, the invention relates to a computer program product comprising a computer-readable storage medium having computer-readable program code embodied therewith, the computer-readable program code configured to implement operations for determining an improved set of values of parameters for operating a Large-Language-Model, LLM, dependent on a set of documents comprising: loading a set of questions and answers, wherein a respective answer corresponds to one of the questions and the questions relate to a content provided by the set of documents; performing repetitions, the repetitions comprising using a respective mode: generating a respective set of chunks of the documents dependent on the set of documents and an input content dependent on the set of chunks of the documents, wherein the generating of the set of chunks and the input content is performed according to the respective mode and the respective mode differs for a respective repetition and is specified by a respective set of values of the parameters, a value of a respective parameter specifying how the generating of the set of chunks or the input content is performed; generating a prompt for the LLM dependent on the input content and a question of the questions; providing the prompt as an input to the LLM and receiving a respective provisional answer in response from the LLM; and performing a comparison between the respective provisional answer and the respective answer corresponding to that question dependent on the prompt that was generated, resulting in a score for the question. The operations further comprise: generating a respective overall score for the respective mode dependent on the resulting scores for the questions; generating training data sets comprising for the modes the respective set of values of the parameters specifying the respective mode and the respective overall score; training a machine-learning module, ML-module, using the sets of values of the parameters of the training data sets as input and the overall scores of the training data sets as target output of the ML-module; and performing a search for the improved set of values of the parameters using the trained ML-module, wherein inputting the improved set of values of the parameters into the trained ML-module results in an improved score greater than a greatest overall score of the training data sets.

In one aspect, the invention relates to a computer system for determining an improved set of values of parameters for generating an improved prompt for a Large-Language-Model, LLM, dependent on a set of documents, comprising: a processor set; a computer-readable storage media; and program instructions stored on the computer-readable storage media to cause the processor set to perform operations. The computer system is configured to load a set of questions and answers, wherein the respective answer corresponds to one of the questions and the questions relate to a content provided by the set of documents. Furthermore, the computer system is configured to perform repetitions, the repetitions comprising using a respective mode.

The performing of the repetitions comprises using a respective mode. Furthermore, the performing of the repetitions comprises generating a respective set of chunks of the documents dependent on the set of documents and generating an input content dependent on the set of chunks of the documents. The generating of the set of chunks and the input content is performed according to the mode. The mode differs for the respective repetition and is specified by a respective set of values of the parameters. The value of the respective parameter specifies how the generating of the set of chunks or the input content is performed.

Furthermore, the performing of the repetitions comprises generating a prompt for the LLM dependent on the input content and a question of the questions.

Furthermore, the performing of the repetitions comprises providing the prompt as an input to the LLM and receiving a respective provisional answer in response from the LLM.

Furthermore, the performing of the repetitions comprises performing a comparison between the provisional answer and the answer corresponding to that question dependent on which the prompt was generated resulting in a score for the question.

Furthermore, the computer system is configured to generate a respective overall score for the respective mode dependent on the resulting scores for the questions.

Furthermore, the computer system is configured to generate training data sets comprising for the modes the respective set of values of the parameters specifying the mode and the respective overall score.

Furthermore, the computer system is configured to train a machine-learning module, ML-module, using the sets of values of the parameters of the training data sets as input and the overall scores of the training data sets as target output of the ML-module.

Furthermore, the computer system is configured to perform a search for the improved set of values of the parameters using the trained ML-module, wherein inputting the improved set of values of the parameters into the trained ML-module results in an improved score greater than the greatest overall score of the training data sets.

### BRIEF DESCRIPTION OF THE DRAWINGS

In the following embodiments of the invention are explained in greater detail, by way of example only, making reference to the drawings in which:

FIG. 1 is a flowchart of a method for determining an improved set of values of parameters for operating a Large-Language-Model (LLM) using a set of questions and answers in accordance with an example of the present subject matter.

FIG. 2 illustrates a generating of chunks dependent on a set of documents;

FIG. 3 depicts a first set of chunks of the set of chunks shown in FIG. 2 and embedding vectors representing the chunks of the first set of chunks;

FIG. 4 shows a question of the set of questions and a question embedding vector representing the question;

FIG. 5 depicts a flowchart illustrating a usage of the LLM for generating a provisional answer dependent on a prompt;

FIG. 6 depicts a table indicating settings for values of parameters for controlling a generation of the prompt shown in FIG. 5 and for controlling an operation of the LLM for generating the provisional answer shown in FIG. 5;

FIG. 7 shows training data sets for training a machine-learning module (ML-module);

FIG. 8 illustrates trial sets for performing a search for a set of improved values of the parameters shown in FIG. 6 using the trained ML-module shown in FIG. 7;

FIG. 9 is a flowchart of method for using the trained ML-module for obtaining a new answer to a new question related to the documents shown in FIG. 2; and

FIG. 10 depicts a computing environment in accordance with an example of the present subject matter.

### DETAILED DESCRIPTION

The descriptions of the various embodiments of the present invention will be presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The improved set of values of parameters, in the following also referred to as improved values, may allow to generate an improved prompt for the LLM dependent on the improved values and receive an improved answer from the LLM in response to inputting the improved prompt to the LLM, in the following referred to as an improved usage. The improved usage may comprise generating a new set of chunks of the documents dependent on the set of documents and generating a new input content dependent on the new set of chunks. The new set of chunks and the new input content may be generated according to a new mode, wherein the new mode may be specified by means of the improved set of values of the parameters. The respective value of the improved set of values of the parameters may specify how the new set of chunks or the new input content is generated.

According to one variant of the improved usage, the new prompt for the LLM may be generated dependent on the new input content and dependent on a selected question of the set of questions. For example, the new prompt may comprise the new input content and the selected question. The new prompt may be provided as a new input to the LLM and a new provisional answer may be received in response from the LLM. As the improved score is greater than the greatest overall score of the training data sets, in most cases a quality, for example an accuracy, of the new provisional answer may be higher than any of the provisional answers generated in the repetitions. Thus, according to this variant, the new provisional answer may be considered as the improved answer in comparison to the provisional answers obtained in the repetitions. Hence, a performance of the LLM may be enhanced.

According to another variant of the improved usage, the new prompt for the LLM may be generated dependent on the new input content and dependent on a new question which may relate to the documents instead of using the selected question. For example, the new prompt may comprise the new input content and the new question. Similarly to the variant described above, the new prompt may be provided as a new input to the LLM and a new answer may be received in response from the LLM. As the improved score is greater than the greatest overall score of the training data sets, in most cases a quality, for example an accuracy, of the new answer may be higher compared to a usage of the LLM for obtaining the new answer according to which the new input would be generated dependent on one of the chunks of the documents generated in one of the repetitions. Hence, the performance of the LLM may be enhanced in case the LLM is used to produce the new answer to the new question.

By using the trained ML-module when performing the search for the improved values, the search for the improved values may be speed up compared to using the LLM for searching for the improved values. Using the LLM for searching the improved values would imply to perform the above described repetition for evaluating each trial of set of values of the parameters anew. However, the generating of the set of chunks dependent on the documents and the generating of the input content, also commonly referred to as retrieval process, may require a number of computational steps which may be about 10 or 100 up to 1,000 times greater than a number of computational steps required for using the trained ML-module for evaluating each trial of set of values of the parameters anew. Each trial of set of values of the parameters may involve a new combination of the values of the parameters.

Typically, a lower number of required computational steps goes along with a shorter time required for evaluating each trial of set of values of the parameters. Hence, the search for the improved values may be speed up by using the trained ML-module. In addition, in case the LLM is run on a first computing device, for example on a central server or a first set of processors, and the generating of the score for the repetitions, the training of the ML-Module and/or the performing of the search is performed on a second computing device, for example on a client device or a second set of processors or a single second processor, a data traffic between the two computing devices may be reduced by using the trained ML-module. Only a limited amount of data exchange for the generating of the set of training data sets, for example sending the prompt to the first computing device and receiving the provisional answer for each training data set from the first computing device, may be performed in this case.

The modes of the repetitions may differ from repetition to repetition. Considering two modes of the modes which may be specified by two sets of values of the parameters, the two modes being different may imply that the value of at least one parameter of the two sets of values is different. As a number of the parameters for specifying the modes is at least two, the repetitions may be performed in the form of nested loops. Within the respective loop of the nested loops a value of one respective parameter of the parameters may be varied with each time the respective loop is repeated.

In one example, a performing of the innermost loop may comprise performing a further repetition, i.e. a further loop. Each time the further loop is repeated a different one of the questions may be selected, in the following referred to as the respective question. Hence, performing several of the further repetitions, i.e. performing several runs of the further loop, may involve repeating: the generating of the input content according to the mode; the generating of the prompt for the LLM dependent on the input content and the respective question; the providing of the prompt as an input to the LLM and receiving a respective provisional answer in response from the LLM; and performing a comparison between the provisional answer and the answer corresponding to that question dependent on which the prompt was generated resulting in a score for the respective question. The performing of the further repetitions may comprise keeping the mode unchanged. The scores for the questions may be stored for computing the respective overall score for the respective mode.

In one example, the questions and answers may be in the form of question data files and answer data files respectively. The questions and answers may comprise words or phrases. In one example, the questions and/or answers may comprise one or more images and/or image series and/or one or more audio files. The content provided by the set of documents may be in form of words, phrases and sentences of the documents. In one example, the documents may comprise one or more images and/or image series and/or one or more audio files. In present applications, LLMs mostly are used for question and answer (Q&A)-tasks on a text basis. However, as Q&A-tasks may involve an increasing use of images in the future, the questions, answers and/or the documents may be in the form media files comprising text, images, image series and/or audio files. In one example, one or more of the questions, answers and documents may comprise only images and/or image series and/or audio files.

The questions may relate to the content of the documents such that at least one word or image or audio file of the respective question may comprise a similar meaning of at least one word or image or audio file of one of the documents.

The prompt for the LLM may comprise a command which instructs the LLM to use the input content for generating the respective provisional answer. For example, the command may be a phrase such as “please use the input content included in this prompt for answering the following question:”. In most applications, the respective prompt generated in the respective repetition may comprise the respective question, the input content generated in the respective repetition and the command.

The LLM may be an artificial intelligence module (AI-module) designed to understand and generate human-like text based on the input it receives. The LLM may be configured to generate the respective provisional answer in response to receiving the respective prompt. The LLM may be trained on vast amounts of text and/or image data from books, articles, and other sources, enabling it to learn language patterns, grammar, facts, and even some reasoning skills. The images for training the LLM may be converted into image embedding vectors in case the LLM is trained on image data. The LLM may be designed in the form of, for example, one of the OpenAI's generative pre-trained transformer (GPT) models, such as GPT models, GPT-2 models, GPT-3®, GPT-4®, or in the form of BERT models, T5 models, RoBERTa models, XLNet models, GPT-Neo models, GPT-J models, LLAMA™ models, BLOOM models, Claude™ models, Cohere™ models, OPT models, or ERNIE models.

As mentioned above, the generating of the set of chunks dependent on the documents and the generating of the input content dependent on the set of chunks for the respective repetition may be referred to as a retrieval process. In most cases, the retrieval process may involve the generating of the chunks. However, an application may be possible in which for a part of the repetitions the retrieval comprises the generating of the input content without generating the chunks dependent on the documents. In this case, a first part of the repetitions may comprise generating of the set of chunks dependent on the documents and a second part of the repetitions may use a predefined set of chunks. The predefined set of chunks may be generated in one of the previous repetitions or separately from the repetitions.

The generating of the set of chunks dependent on the documents as a part of the retrieval process may comprise dividing the set of documents into the chunks. In one example, the chunks may be proper subsets of the documents. Alternatively, the chunks may have common parts. The retrieval process may further comprise calculating embedding vectors dependent on the chunks using an embedding model. The respective embedding vector may represent a semantic meaning of the respective chunk of the set of chunks generated in the respective repetition.

The generating of the input content for the respective repetition may comprise generating the input content dependent on the respective question. For example, the generating of the input content for the respective repetition may comprise comparing the embedding vectors with one or more further embedding vectors representing the respective question. In one example, the one further embedding vector may represent the respective question, in the following also referred to as respective question embedding vector. In this case, the retrieval process may comprise calculating the question embedding vector dependent on the respective question using the embedding model.

In one example, it may be possible to determine a set of contextualized embedding vectors for the respective question on the basis of the respective question embedding vector. The contextualized embedding vectors may be one example of the further embedding vectors. In this case, the generating of the input content for the respective repetition may comprise comparing the embedding vectors with one or more vectors of the set of contextualized embedding vectors for the respective question. In one example, the retrieval process may comprise calculating a concatenated embedding vector dependent on the contextualized embedding vectors and linear factors. The respective linear factor may weight the respective contextualized embedding vector for obtaining the concatenated embedding vector. The concatenated embedding vector may be one example of the further embedding vector. In this case, the generating of the input content for the respective repetition may comprise comparing the embedding vectors with the concatenated embedding vector.

The comparing of the embedding vectors with the respective question embedding vector or the concatenated embedding vector may involve calculating a similarity score for the respective embedding vector. In one example, the similarity score may be the cosine similarity. The retrieval process may further comprise ranking the embedding vectors according to their similarity score and selecting a predefined number of chunks of the set of chunks for the respective repetition. In one example, the selected chunks may be the chunks being ranked the highest according to their similarity score. The generating of the prompt may comprise generating the input content dependent on the selected chunks. In one example, the input content may comprise the selected chunks.

The score for the respective question may be a metric for judging how similar the provisional answer is to the answer corresponding to the respective question for which the prompt was generated, in the following referred to as target answer. In the following it may be assumed that a higher value of the score goes along with a better performance of the LLM with respect to producing the provisional answer as similar as possible to the target answer. The metric may be an accuracy or performance metric, such as the F1-score for example.

The F1 Score is a common metric used to assess the performance of Question-Answering Large Language Models (LLMs), particularly when partial correctness of answers is acceptable. It measures the overlap between the words in the provisional answer and the words in the target answer. The F1 Score is the harmonic mean of Precision and Recall, offering a balanced measure that accounts for both false positives and false negatives. Precision refers to the number of correctly predicted words in the provisional answer divided by the total number of words in the provisional answer. It essentially measures the accuracy of the words provided by the LLM. Recall, on the other hand, is the number of correctly predicted words of the provisional answer divided by the total number of words in the target answer, assessing how many relevant words the model successfully retrieved. The F1 Score is calculated using the formula: F1 Score=2×(Precision×Recall)/(Precision+Recall). A higher F1 Score indicates a greater overlap between the provisional answer and the target answer, which may imply that the LLM may perform well in terms of retrieving relevant and accurate information. This metric may be generally useful in Q&A tasks where exact matches are not necessary, and partial correctness can still be valuable.

It is understood that, according to other examples, it is possible that the metric may be Exact Match (EM), Mean Reciprocal Rank (MRR), human evaluation, Precision, Recall, or passage-level metrics like Precision at k.

The term “module” as used herein refers to any known or in the future developed hardware, software such as an executable program, artificial intelligence, fuzzy-logic or combination hereof for performing a function associated with the “module” or being a result of having performed the function associated with the “module”.

In one example, the ML-module may comprise one or more artificial neural networks and/or one or more decision trees. The training of the ML-module may involve learning from the training data sets by adjusting the ML-module in order to best represent patterns, relationships, or structure in the training data sets as a whole.

In one example, the ML-module may be comprise mathematical functions with parameters. The functions of the ML-module, in the following also referred to as ML-functions, may be linked to each other. For example, an output of one or more ML-functions may be linked to an input of one or more other ML-functions. The ML-functions as a whole may be considered as a composite function. Values of the parameters of the ML-functions may be adaptable to the training data sets. The ML-module may be configured such that by adapting the values of the parameters of the ML-functions a cost or loss function may be minimized.

The cost or lost function may be a function of a deviation of training output values of the composite function from the overall scores of the training data sets. The training of the ML-module may involve computing the respective training output value of the composite function dependent on the set of values of the parameters of the respective training data set. The training may further comprise computing the cost or loss function on the basis of deviations, wherein the respective deviation may indicate a deviation of the respective training output value from the overall score of the respective training data set. The training may further comprise adapting the values of the parameters of the ML-functions dependent on the cost or loss function, for example dependent on partial derivatives of the cost or loss function. The training may involve computing the respective partial derivative as a derivative of the cost or loss function with respect to the respective parameter of the parameters of the ML-functions. The training may involve various repetitions of the adapting of the values of the parameters of the ML-functions until the cost or loss functions is below a predefined threshold.

In case the ML-module comprises a neural net, the parameters of the ML-functions may be weights indicating connection strengths between neurons of the neural net. The training may involve performing one or more learning algorithms, such as gradient descent, stochastic gradient descent, mini-batch gradient descent, momentum, Nesterov accelerated gradient, Adagrad, RMSProp, Adam, backpropagation, step decay, exponential decay, adaptive learning rates, L1 and L2 regularization, dropout, early stopping, and/or performing an initialization method, such as He initialization or Xavier initialization.

The performing of the search for the improved values comprise generating trial sets of values of the parameters, in the following also referred to as trial sets. The respective trial set may comprise a trail value for the respective parameter. The trial sets may each have the same dimension as the respective set of values of the parameters of the training data sets. All mathematical possible combinations of values of the parameters may reside in a vector space, in the following also referred to as search space. In one example, the trial sets may comprise a random value for each parameter. In this case, the search may be a random search.

In another example, boundaries of an admissible region in the search space may be defined. The admissible region may specify all admissible combinations of the values of the parameters. Furthermore, the admissible region may be divided into subregions. A size of the subregions may be dependent on a predefined resolution value. According to one example, a centroid of the respective subregion may specify a respective combination of values of the parameters and by that may specify the respective trial set of the trial sets.

The performing of the search for the improved values may comprise using the trial sets one by one for generating trial output values of the ML-module. The ML-module may compute the respective trial output value dependent on the values of the respective trial set using the adapted ML-functions. The trial set with which the ML-module computes the greatest trial output value may be specified as the improved set of values of the parameters.

Performing the repetitions for generating the scores for the questions and the overall score for the respective mode may comprise setting the values of the respective set of the parameters, in the following also referred to as initializing. The initializing may comprise performing a DOE for setting the values of the respective set of the parameters, for example according to a full factorial design or a fractional factorial design. In one example, the values of the respective set of the parameters may be set randomly. Alternatively, the initializing may comprise dividing the admissible region into further subregions and selecting a part of the subregions. A centroid of the respective selected further subregion may represent the respective set of parameters in this case. A number of the subregions defined for generating the trial sets may be greater than a number of the further subregions, for example 10, 100, or up to 1,000 times greater.

According to one example, the method may further comprise receiving the new question mentioned above which is related to the set of documents. According to this example, the method may further comprise generating the new set of chunks of the documents dependent on the set of documents and generating the new input content dependent on the new set of chunks. The generating of the new set of chunks and the new input content may be performed according to the new mode mentioned above. The new mode may be specified by means of the improved set of values of the parameters. The respective value of the improved set of values of the parameters may specify how the generating of the new set of chunks or the new input content is performed. According to this example, the method may further comprise generating the new prompt for the LLM dependent on the new input content and the new question. The method may further comprise providing the new prompt as a new input to the LLM and receiving the new answer in response from the LLM. The method may further comprise providing the new answer as a response to the new question. This example describes one of the above mentioned variants of the improved usage of the LLM.

According to one example, the ML-module may comprises a decision tree. The training of the ML-module may comprising training the decision tree. The decision tree may offer several advantages over an artificial neural network (ANN), primarily due to its interpretability and simplicity. The decision tree may be easy to understand and to visualize, providing a clear, structured decision-making process, unlike the “black-box” nature of the ANN. In addition, a training of the decision tree may be less computationally intensive and may require less data preprocessing, and may work better with smaller datasets compared to the ANN. Furthermore, the decision tree may handle missing values more effectively and may not assume any linear relationship between the parameters and the overall score, naturally capturing complex relationships between the parameters. Additionally, the decision tree may provide insights into importance of the respective parameter. The decision tree may also inherently ignore irrelevant parameters. Using the decision tree may make the ML-module more efficient and robust and interpretable compared to a usage of the ANN.

According to one example, the ML-module may comprises a set of decision trees. The training of the ML-module may comprise generating proper subsets of the training data sets, wherein the proper subsets are random samples of the training data sets. The training of the ML-module may further comprise training the respective decision tree using the respective subset of the training data sets. Performing the training of the ML-module may further comprise performing the Random Forest or Gradient Boosted Trees method.

Using the set of decision trees instead of just one decision tree may offer several advantages. Firstly, it may improve a predictive accuracy of the ML-module, as multiple trees working together may average out errors and may provide more reliable results. A single decision tree may overfit the training data sets. However, the set of decision trees may reduce an overfitting of the ML-module with respect to the training data sets. By that generalization capabilities of the ML-module may be enhanced. Additionally, using the set of decision trees may increase a robustness of the ML-module to noise and data variations in the training data sets, making the ML-module less sensitive to outliers in the training data sets. The set of decision trees may also model complex, non-linear relationships of the parameters more effectively than a single decision tree, capturing intricate interactions among the parameters. The variance of the ML-module may be reduced as well, making it more stable and less influenced by small changes in the training data sets. Furthermore, using the set of trees may provide a more reliable estimate of the importance of the respective parameter, offering valuable insights into which parameters may have the most impact on the overall score.

According to one example, the performing of the search may comprise performing a grid search, a random search or performing the search on the basis of a genetic algorithm. Performing the grid search or the random search may involve dividing the search space into the subregions for specifying the trial sets. By performing the grid search all specified combinations of values of parameters may be tested. Such a test may comprise inputting the respective trial set to the ML-module as input and receiving a trial score from the ML-module as a response. The trial set dependent on which the ML-module computes the greatest trial score may be specified as the improved set of values of the parameters. Performing the grid search may increase the likelihood of finding the improved values as an optimal set of values of the parameters. The grid search may be easy to implement, and may ensure reproducibility since its results are deterministic. Additionally, the grid search may be performed in parallelized manner, making it efficient and scalable when utilizing multiple processors or distributed systems.

Performing the search on the basis of a genetic algorithm may increase the efficiency and scalability of the search over performing the grid search. Genetic algorithms may efficiently explore large and complex search spaces without evaluating every possible combination of the values of the parameters, saving time and computational resources. The genetic algorithm may balance exploration and exploitation, using evolutionary techniques to focus on promising regions of the search space while still exploring new combination of the values of the parameters. Using the genetic algorithm for the search may be more effective at finding the optimal or near-optimal set of values of the parameters.

According to one example, the parameters of the set of parameters may represent input features of the ML-module. The training of the ML-module may comprise determining a feature importance score for the respective input feature. The feature importance score may indicate a relative impact of the respective input feature on a prediction of the ML-module. In this context, the predictions of the ML-module may be in the form of the overall scores generated for the modes. In one example, performing the training of the ML-module may comprise performing the random forest method, for example the random forest regression method, and obtaining as a result the feature importance scores of the parameters.

The feature importance score may allow to select those parameters whose values may be varied more than the values of the other parameters when performing the search. In one example, performing the search may comprise dividing the admissible region into the subregions dependent on the feature importance scores of the parameters. In this case, the admissible region may be divided more finely along those dimensions of the search space that correspond to the parameters whose feature importance score is higher. The higher the feature importance score of the parameter, the higher a resolution of the subregions and by that a resolution of the trial sets may be in that dimension which corresponds to the respective parameter.

According to one example, the method may further comprise selecting a chunk size for the chunks of the set of chunks for the respective repetition. A value of a parameter of the set of parameters may specify the chunk size for the respective repetition, in the following referred to as the first parameter. Using the first parameter as one of the parameters may have the following advantage. Typically, smaller chunks may improve a retrieval of highly relevant details of the documents, while larger chunks may retain a broader context of the context. Performing the search for the improved values and by that searching for an improved value of the first parameter may enhance the chance that the chunk size may be optimized with respect to a balance between retrieval precision and context richness.

According to one example, the method may further comprise selecting chunks of the set of chunks and generating the input content dependent on the selected chunks for the respective repetition. A value of a parameter of the set of parameters may specify a number of the selected chunks, in the following referred to as second parameter. As described above, the retrieval process may comprise ranking the embedding vectors according to their similarity score and selecting the predefined number of chunks of the set of chunks for the respective repetition. The predefined number of chunks may be the number of the selected chunks, i.e. the value of the second parameter.

A high number of the selected chunks may allow to present more content of the documents as input to the LLM. Thus, a chance of increasing the overall score may be enhanced by using a higher number of the selected chunks. However, using a high number of the selected chunks may be computationally expensive. Hence, a low number of the selected chunks may allow to perform more repetitions and to obtain a higher number of training data sets. This may result in a more accurate ML-module. In one example, a low number of the selected chunks may allow for greater retrieval precision, as the LLM may access highly specific and relevant pieces of the documents. By that an inclusion of irrelevant content of the documents may be reduced. Performing the search for the improved values and by that searching for an improved value of the second parameter may enhance the chance to generate an optimal set of training data sets for generating the ML-module as accurate as possible.

According to one example, the method may further comprise selecting a size of common parts of the set of chunks for the respective repetition. The method may further comprise, for the respective repetition, performing the generating of the set of chunks such that the respective chunk of the set of chunks comprises at least one common part which is comprised by another chunk of the set of chunks. A value of a parameter of the set of parameters may specify the size of the common parts, in the following referred to as the third parameter. The common parts, i.e. overlapping parts, may allow for accounting for information of the documents that spans across boundaries of the chunks. The common parts may prevent a loss of crucial context that might be needed to fully understand or interpret a given piece of the content of the documents. However, the smaller the size of the common parts, the more information of the documents may be included in the prompt for the respective repetition, given a limited maximal number of tokens for the prompt. Hence, performing the search for the improved values and by that searching for an improved value of the third parameter may enhance the chance to find an optimal balance between preserving crucial context included in more than one chunk and to include as much information as possible in the new prompt.

According to one example, the method may further comprise selecting, for the respective repetition, a type of the embedding model for generating the respective embedding vector dependent on the respective chunk of the set of chunks. The respective embedding vector may represent the respective chunk, as mentioned above. A value of a parameter of the set of parameters may specify the type of the embedding model, in the following referred to as fourth parameter. The selection of the type of the embedding model for the respective repetition may comprise selecting the embedding model as one model of a list of embedding models. The list of embedding models may comprise Word2Vec models, GloVe models, FastText models, ELMo models, BERT models and/or Sentence-BERT models, and transformer-based models like GPT models, RoBERTa models, and/or DistilBERT models. The value of the fourth parameter may be a natural number.

Word2Vec models and GloVe models may be efficient and may capture word relationships well. FastText models may improve on handling out-of-vocabulary words by using subword information. ELMo models may use contextualized embeddings. This may allow to handle polysemy. BERT models may provide very rich contextualized embeddings suitable for various natural language processing (NLP) tasks. Sentence-BERT models may be optimized for sentence-level similarity tasks. Generally, it may be possible that various embedding models may perform differently dependent on the content of the set of documents. As the content of the documents may be dependent on an application of the computer system, one embedding model of the list may perform better than another when applied to one industrial branch, for example automotive, and it may be the other way round in case the models are applied to another industrial branch, for example mining or medical care. Thus, performing the search for the improved values and by that searching for an improved value of the fourth parameter may enhance the chance to find the best embedding model among the models comprised by the list for the retrieval process using the documents.

According to one example, the method may further comprise selecting a respective size of embedding vectors for the respective repetition. A respective value of a parameter of the set of parameters may specify the respective size of the embedding vectors, in the following referred to as fifth parameter. Smaller embedding vectors may capture more general and broad semantic meanings of the content of the documents and may enhance generalization capabilities of the computer system. That may be helpful in case the questions used in the repetition may comprise a high variation with respect to their context. Larger embedding vectors may be suited for capturing more nuanced and specific features, improving the precision of the provisional answers. This may enhance capabilities of the computer system to provide specific provisional answers. By performing the search for the improved values and by that searching for an improved value of the fifth parameter a balance between generalization and specificity may be achieved given the content of the documents. The value of the fifth parameter may vary with a variation in the content of the documents, i.e. with the field of application of the computer system.

According to one example, the method may further comprise selecting a size of the provisional answer for the respective repetition. A value of a parameter of the set of parameters may specify the size of the provisional answer, in the following referred to as sixth parameter. Selecting the size of the provisional answer may mean restricting the size of the provisional answer to the selected size. The prompt for the respective repetition may comprise a command which describes the provisional answer to have at maximum the selected size.

A smaller size of the provisional answer may result in more precise provisional answers. A larger size of the provisional answer may result in more detailed and context-rich provisional answers. By varying the restricted size of the provisional answers in the repetitions, a close to optimal size of the new answer may be found based on the trained ML-module and the search for the improved values, considering the set of documents and by that the field of application of the computer system. A balance between conciseness and comprehensiveness may be found by searching for an improved value of the sixth parameter with respect to the application of the computer system.

According to one example, the method may further comprise selecting a value of a seventh parameter of the set of parameters for the respective repetition. The seventh parameter may indicate a degree of repetition of similar context in the provisional answer. The seventh parameter may also be known as generation-repetition-penalty parameter. The higher the value of the seventh parameter, the lower may be a likelihood of the LLM producing repetitive or redundant content in the respective provisional answer. The LLM may be configured to assign a cost to repeating words or phrases in the provisional answer dependent on the value of the seventh parameter. The higher the value of the seventh parameter, the higher a variation of the content of the provisional answer may be.

Setting the value of the seventh parameter too high may provoke the LLM to avoid necessary repetitions and may provoke the LLM to produce unnatural or incoherent text. In natural language, some repetition may be important for readability and coherence. If the value of the seventh parameter is excessively high, the model might forcefully rephrase or omit important information. This may produce awkward, confusing, or incomplete content of the provisional answers and in the new answer. Therefore, performing the search for the improved values and by that searching for an improved value of the seventh parameter may enable the LLM to generate a good balance between unwanted redundancy and clarity of the content of the provisional answers and by that of the content of the new answer.

According to one example, the method may further comprise selecting a type of the LLM for the respective repetition. A value of a parameter of the set of parameters may specify the selected type of the LLM, in the following referred to as eighth parameter. The computer system may be configured to select the LLM as one LLM from a list of LLMs. The list may comprise OpenAI's GPT models, such as GPT-3 models or GPT-4 models, or further LLMs, such as BERT models, LLaMA models, BLOOM models, Claude models, Cohere models, OPT models, or ERNIE models. Depending on the content of the documents one of the LLMs of the list may perform better than the other. Thus, performing the search for the improved values and by that searching for an improved value of the eighth parameter may result in finding the best type of LLM for the set of documents and the given questions and answers.

According to one example, the method may further comprise selecting a value of a ninth parameter of the set of parameters for the respective repetition, wherein the value of the ninth parameter may indicate a degree of modification of a probability distribution of the LLM. Depending on how the probability distribution used by the LLM for generating the provisional answer is modified, a randomness of the provisional answer may be varied. The ninth parameter may be known as generation-temperature parameter. The ninth parameter may allow to adjust how deterministic or creative the LLM may create the provisional answers and the new answer. Thus, performing the search for the improved values and by that searching for an improved value of the ninth parameter may allow to find a balance between creativity and reliability of the content of the provisional answers and the new answer.

According to one example, the method may further comprise selecting a type of retrieval method for the respective repetition. The generating of the input content may comprise performing the selected retrieval method for obtaining the input content. A value of a parameter of the set of parameters may specify the selected type of retrieval method, in the following referred to as tenth parameter. The selected type of retrieval method may be one of a list of retrieval methods comprising for example, BM25 methods, TF-IDF methods, Dense Vector Retrieval methods (such as FAISS and ScaNN), Semantic Search methods, ElasticSearch methods, Approximate Nearest Neighbor (ANN) Search methods, Hybrid Retrieval methods, Maximum Inner Product Search (MIPS) methods, Graph-based Retrieval methods, and Memory-Augmented Methods. BM25 and TF-IDF methods may be considered as keyword-based methods which may rely on statistical measures of term frequency and document importance. Dense Vector Retrieval and Semantic Search methods may use a neural network based embedding model to capture the semantic meaning of the chunks, enabling more context-aware matching. ElasticSearch methods may allow the combination of both keyword-based and dense vector search capabilities. Approximate Nearest Neighbor (ANN) Search methods may allow the find approximate matches between the question embedding vector and the embedding vectors. This may be an advantage in case a size of the set of documents is very large and the number of chunks of the set of chunks is large. Graph-based Retrieval may allow the organization of information of the chunks in a graph structure to capture relationships between the chunks. This may enable to perform quicker searches based on connectivity or similarity.

The different retrieval methods may vary in their approach to match the question for the respective repetition with the documents and/or with the chunks. Depending on which retrieval method may be the selected one, the input content may be generated more rapidly. Furthermore, according to which of the retrieval methods is the selected one a semantic understanding of the documents and/or of the chunks and/or a precision of the provisional answer may differ. Hence, performing the search for the improved values and by that searching for an improved value of the tenth parameter may allow to adapt the semantic understanding capabilities of the computer system for generating the input content to the content of the documents.

According to one example, the method may further comprise, for the respective repetition, selecting a chunking method from a set of chunking methods for generating chunks dependent on documents. The method may further comprise generating the set of chunks according to the selected chunking method. A value of a parameter of the set of parameters may specify the selected chunking method, in the following referred to as eleventh parameter. The chunking methods may vary with respect to how the documents may be split into the chunks. For example, the different chunking methods may be designed to split the documents either by sentences, paragraphs, fixed word counts, or based on semantic units. The set of chunking methods may comprise fixed-length chunking, sentence-based chunking, paragraph-based chunking, semantic chunking, semantic chunking and/or sliding window chunking, for example.

Performing a fixed-length chunking method may comprise dividing the documents into chunks of a set number of words or characters, such as 200 words per chunk, without considering sentence or paragraph boundaries. Performing a sentence-based chunking method may comprise dividing the documents such that each chunk contains complete sentences, often grouping 3 to 5 sentences together. Performing a paragraph-based chunking method may comprise dividing the documents such that the chunks are created based on paragraph divisions, which may vary in size depending on the level of detail needed. Performing a semantic chunking method may comprise dividing the documents such that the chunks may be in the form of contextually meaningful chunks. By that the content of the documents may be organized by topics or subheadings. Performing a sliding window chunking method may generate overlapping parts between chunks by moving a window over the text. Performing the sliding window method may result in generating the common parts mentioned above. Performing a topic-based chunking method may comprise performing algorithms like topic modeling to separate the documents into distinct themes. In this case, each chunk may correspond to a respective cohesive subject. Hence, performing the search for the improved values and by that searching for an improved value of the eleventh parameter may allow to find the best chunking method with respect to the set of documents which may vary with respect to the application of the computer system.

According to one example, the method may further comprise generating the embedding vectors for the respective repetition, wherein the respective embedding vector represents the respective chunk of the set of chunks. The method may further comprise generating the further embedding vector, mentioned above, which represents the question. Alternatively, the method may further comprise generating or a set of further embedding vectors which represent the question, such as the further embedding vectors mentioned above, for example the contextualized embedding vectors. The method may further comprise selecting a type of similarity metric. A value of a parameter of the set of parameters may specify the selected type of similarity metric, in the following referred to as twelfth parameter. The method may further comprise performing a comparison between the embedding vectors and the further embedding vector using the selected similarity metric. Alternatively, the method may further comprise performing a comparison between the embedding vectors and the set of further embedding vectors using the selected similarity metric. The method may further comprise selecting a subset of the chunks dependent on a result of the comparison. The performing of the comparison may produce a value of the similarity metric for the respective chunk. The method may further comprise producing a ranking list. The ranking list may list the chunks according to their value of the similarity metric. The selecting of the subset of the chunks may involve selected a predefined number of chunks comprising the highest value of the similarity metric. The predefined number of chunks may be the above mentioned number of the selected chunks. The method may further comprise generating the input content dependent on the selected subset of the chunks.

The selecting the type of the similarity metric may comprise selecting the similarity metric as one similarity metric from a list of similarity metrics. The list of similarity metrics may comprise the cosine similarity, the Euclidean distance, the Manhattan distance, the inner product, for example. Performing the search for the improved values and by that searching for an improved value of the twelfth parameter may allow to find the most appropriate similarity metric with respect to the set of documents and the questions. In one example, the selecting of the type of the retrieval method may comprise selecting the type of the similarity metric.

According to one example, the method may further comprise performing a selection of a value of a parameter of the embedding model for generating the respective embedding vector dependent on the respective chunk of the set of chunks. A value of a parameter of the set of parameters may specify the value of the parameter of the embedding model, in the following referred to as thirteenth parameter. In one example, the parameter of the embedding model may comprise which type of query, value or key vector to use in case the embedding model may comprise different sets of query, value or key vectors to select. In another example, the parameter of the embedding model may be a parameter of a function of the embedding model, for example a softmax function for computing contextualized embedding vectors inside the embedding model. Performing the search for the improved values and by that searching for an improved value of the thirteenth parameter may allow to tune the embedding model for adapting the embedding model to the content of the documents and/or the questions and/or answers.

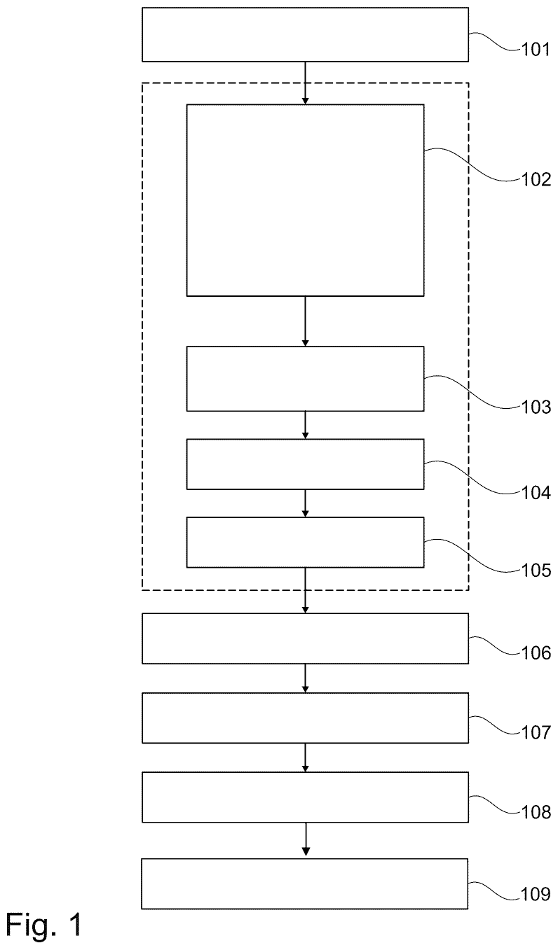

FIG. 1 is a flowchart of a method for determining an improved set of values of parameters for operating a Large-Language-Model, LLM, dependent on a set of documents in accordance with an example of the present subject matter. For the purpose of explanation, the method described in FIG. 1 may be implemented in the system illustrated in FIG. 10 but is not limited to this implementation. of operational steps to be performed by processor set 810 of computer 801

The method may comprise the following steps. A processor set 810 of computer 801 shown in FIG. 10 may be configured to perform the steps in the form of operational steps. In step 101, a set of questions and answers may be loaded. An operating system 822 of the computer 801 may be configured to load the set of questions and answers into a cache 821 of the computer 801. Furthermore, the operating system 822 may be configured to load code of block 900 for determining the improved set of values of parameters for operating a Large-Language-Model according to one of the above described variants into the cache 821. The code of block 900 may comprise instructions. The instructions may provoke the processor set 810 to perform the steps of the method when executing the instructions. The computer 801 comprising the code of block 900 may be considered as being configured to execute the steps of the method. More precisely, the computer 801 with the cache 821 storing the code of block 900 may be considered as being configured to execute the steps of the method.

The respective answer may correspond to one of the questions. The questions may relate to a content provided by the set of documents. The code of block 900 may comprise one or more commands which provoke the processor set 810 to perform repetitions when executing the code of block 900. The respective repetition may comprise steps 102, 103, 104, and 105 and may be performed according to a respective mode. The mode may be different for the respective repetition.

In step 102, a respective set of chunks of the documents may be generated dependent on the set of documents. In addition, in step 102, an input content may be generated dependent on the set of chunks of the documents. The generating of the set of chunks and the input content may be performed according to the mode. The mode may be specified by means of a respective set of values of the parameters. The value of the respective parameter may specify how the generating of the set of chunks or the input content is performed.

In step 103, a prompt for the LLM may be generated dependent on the input content and a question of the questions. In step 104, the prompt may be provided as an input to the LLM and a respective provisional answer may be received in response from the LLM. In step 105, a comparison between the provisional answer and the answer corresponding to that question dependent on which the prompt was generated may be performed. The comparison between the provisional answer and the answer may result in a score for that question for which the prompt was generated.

The steps 102, 103, 104 and 105 for the respective mode may be repeated for each question of the set of questions keeping the respective mode unmodified resulting in a score for the respective question, in the following referred to as respective question score.

In step 106, a respective overall score for the respective mode may be generated dependent on the resulting scores for the questions. In one example, the overall score may be an average over the question scores.

In step 107 of the method, training data sets may be generated. The respective training data set of the training data sets may comprise the respective set of values of the parameters specifying the respective mode used in the respective repetition and the respective overall score.

In step 107, a machine-learning module, ML-module, may be trained using the sets of values of the parameters of the training data sets as input and the overall scores of the training data sets as target output of the ML-module.

In step 108, a search for the improved set of values of the parameters may be performed using the trained ML-module. The improved set of values of the parameters, also referred to as improved values, may be determined such that an inputting of the improved set of values of the parameters into the trained ML-module may result in an improved score greater than the greatest overall score of the training data sets.

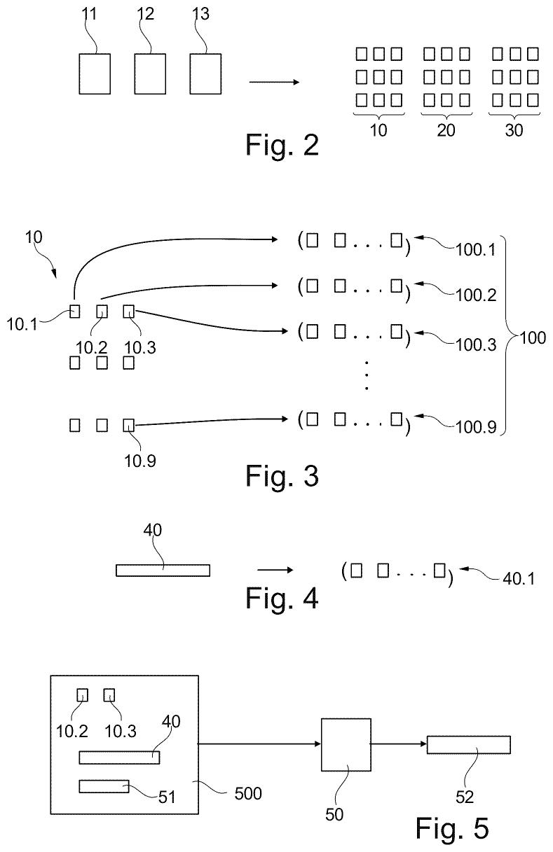

FIG. 2 depicts a set of documents comprising a first document 11, a second document 12 and a third document 13 as an example of the set of documents. In another application the set of documents may comprise 100 or more, for example 1,000 documents. The processor set 810 may be configured to perform a partition of the documents and the generating of the input content according to one of the above mentioned variants and according to the mode of the respective repetition. The respective mode may be prescribed by a selection of the value of the respective parameter of the parameters.

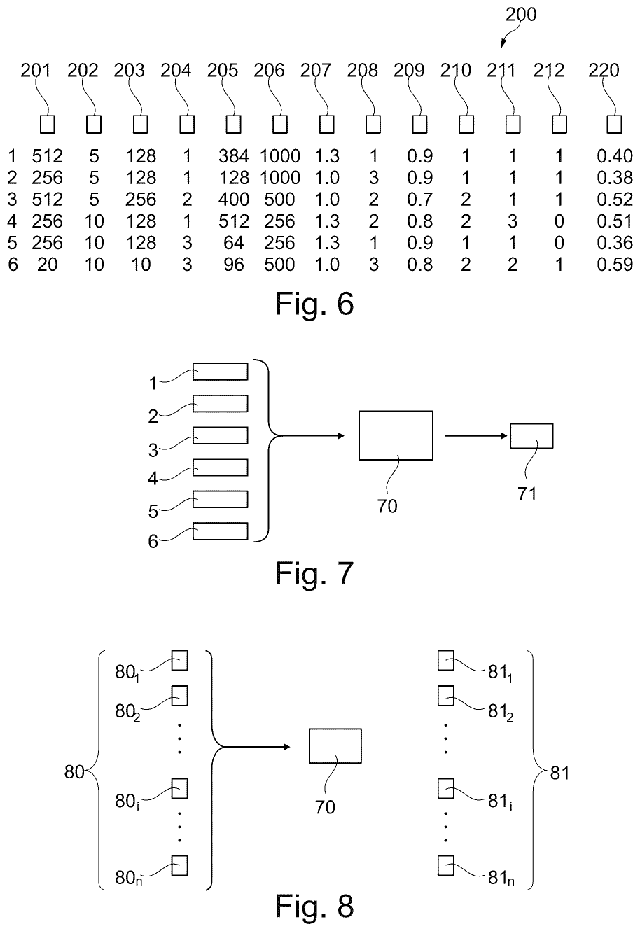

The parameters may comprise the above described first, second, third, fourth, fifth, sixth, seventh, eighth, ninth, tenth, eleventh, twelfth and/or thirteenth parameter. The first, second, third, fourth, fifth, sixth, seventh, eighth, ninth, tenth, eleventh, and twelfth parameter may be labelled as first parameter 201, second parameter 202, third parameter 203, fourth parameter 204, fifth parameter 205, sixth parameter 206, seventh parameter 207, eighth parameter 208, ninth parameter 209, tenth parameter 210, eleventh parameter 211 and twelfth parameter 212 as shown in FIG. 6.

FIG. 6 depicts a table 200 indicating a selection of the values of the parameters for an exemplary six repetitions. Each row of table 200 may indicate the selected value for the parameters for the respective repetition. For example, the first row may show the selection of the values of the parameters for the first repetition. In the following, the selected values of the parameters for the first repetition are explained in detail. The first row may indicate that the value of the first parameter 201 is set equal to 512 which may imply that the chunk size of the chunks is equal to 512 tokens.

A token such as the 512 tokens may be the smallest sequence of characters that has semantic meaning. For example, in natural language processing (NLP), a token may refer to a word, a syllable or punctuation mark. For example, in the sentence “Hello, world!”, the tokens may be “Hello”, “,”, “world”, and “!”. A token may comprise one or more characters.

FIG. 2 may illustrate a partition of the documents into 9 chunks, which are shown in the form of unlabeled rectangles in FIG. 2, respectively. Thus, as a result of chunking the first document 1, a first set of chunks 10 may be obtained. Similarly, as a result of chunking the second document 2, a second set of chunks 20 may be obtained. Analogously, as a result of chunking the third document 3, a third set of chunks 30 may be obtained. The first set of chunks 10, the second set of chunks 20 and the third set of chunks 30 taken together may be considered as one example of the above mentioned respective set of chunks of the documents generated in step 102 for the respective repetition. According to the example given in table 200, the value of the eleventh parameter 211 in the first row is set equal to 1 which may imply that a first chunking method may be used for creating the set of chunks. For example, the first chunking method may be sentence-based chunking. A second chunking method, indicated with a value 2 in table 200, may be a paragraph-based chunking method. A third chunking method, indicated with a value 3 in table 200, may be a semantic chunking method.

According to the example given in table 200, the value of the third parameter 203 is set equal to 128 which may imply that the size of the common parts in the first set of chunks 10 may be equal to 128 tokens. The value of the fourth parameter 204 for the first repetition is set to “1” which may indicate that the selected embedding model for generating embedding vectors for the chunks may be the first type of embedding model comprised by the code of block 900. The first type of embedding model may be a Word2Vec model. A second type of embedding model may be a BERT model and may be specified by the value “2” in the table 200. A third type of embedding model may be a FastText model and may be specified by the value “3” in the table 200.

The computer 801 may be configured to generate a respective embedding vector for the respective chunk using the selected embedding model, as shown in FIG. 3. For example, the set of processors 810 may compute a first embedding vector 100.1 for a first chunk 10.1 of the first set of chunks 10 on the basis of the selected embedding model. In one example, the processor 810 may load one or more values of parameters of one or more neural nets of the selected embedding model into the cache 821 for computing the embedding vectors. The processor 810 may further provide the first chunk 10.1 as input to the selected embedding model and receive the first embedding vector 100.1 in response from the selected embedding model. Entries of the first embedding vector 100.1 are shown in the form of unlabeled rectangles for simplicity. The entries may be real numbers. Analogously, a second embedding vector 100.2 may be generated for a second chunk 10.2 of the first set of chunks 10 and a third embedding vector 100.3 may be generated for a third chunk 10.3 and a ninth embedding vector 100.9 for a ninth chunk 10.9 of the first set of chunks 10 may be generated. Together they may form a first set of embedding vectors 100.

FIG. 4 depicts a question 40 shown as an example of the respective question used for the respective repetition. The respective question may be selected from the set of questions. The processor 810 may provide the question 40 as input to the selected embedding model and receive a question embedding vector 40.1 in response from the selected embedding model.

Typically, the performing of the repetitions may comprise several subsets of repetitions. The repetitions may be considered as several nested loops. Within the respective loop of the nested loops a value of one respective parameter of the parameters may be varied with each time the respective loop is passed through. Hence, to each parameter one respective loop may be associated. An order of the loops may be of minor importance. One of the loops may be associated to a variation of the question for generating the prompt, in the following referred to as question loop. The question loop may be an example of the above mentioned further loop. It may be practical to select the question loop as the innermost loop of the loops. By that, for each combination of values of the parameters the overall score may be generated without storing scores generated for more than one combination of values of the parameters.

It is understood that it is possible to perform the repetitions such that only values of a subset of the above mentioned thirteen parameters were modified after a completion of all repetitions. Not all parameters of the above mentioned thirteen parameters may be of interest depending on the application case of the method. For example, in some instances it may be practical to keep the value of the first parameter 201, the third parameter 203 and the eleventh parameter 211 constant for all repetitions. This may result that the set of chunks of the documents are generated in a first loop pass, i.e. first execution, of the repetitions and remain unchanged in the remaining executions of the repetitions. In that context it is mentioned again that in step 102, the value of the respective parameter of the parameters may specify how the generating of the set of chunks or the input content is performed. The value of the respective parameter to be varied when performing a respective one of the nested loops may either prescribe how the chunks are created or how the input content is created.

Referring back to FIG. 6, the first row of the table 200 indicates that the value of the fifth parameter 205 is set equal to 384 which may mean that the size of the embedding vectors 100 and 40.1 may be equal to 384. The same may hold for a size of embedding vectors representing the chunks of the second set of chunks 20 and the third set of chunks 30, referred to as embedding vectors of the other chunks. The embedding vectors of the other chunks may be computed in the same manner as the embedding vectors 100 and are not shown in the figures for clarity.

The set of processors 810 may compare the question embedding vector 40.1 with the embedding vectors 100 and the embedding vectors of the other chunks individually using a similarity metric. In one example, the similarity metric may be selected. The first row depicts that the value of the twelfth parameter 12 is set equal to “1” for the first repetition. According to example shown in FIG. 6, the value “1” may indicate a first type of similarity metric. The first type may be the cosine similarity, for example. The value “0” may indicate a second type of similarity metric. The second type may be the Euclidean distance for example.

The set of processors 810 may be configured to compute a similarity score for each of the embedding vectors 100 and the embedding vectors of the other chunks using the selected similarity metric. Furthermore, the set of processors 810 may be configured to rank these vectors according to their similarity score and select a predefined number of those chunks that correspond to the embedding vectors with the highest similarity score.

The predefined number of chunks to be selected may be the above mentioned number of the selected chunks, i.e. the value of the second parameter 202. In the first repetition, the value of the second parameter 202 may be equal to 5 as shown in the first row of the table 200.

Furthermore, the set of processors 810 may be configured to generate an input content using a selected retrieval method. For the first repetition, the first type of retrieval method may be selected which is indicated by the value of the tenth parameter 210 in the first row of the table 200 being equal to “1”. In one example, the first type of retrieval method may be Dense Vector Retrieval. The second type of retrieval method may be an ElasticSearch method, indicated by the value “2” of the tenth parameter 210. According to the example given in the figures, the input content may comprise the second chunk 10.2 and the third chunk 10.3 of the first set of chunks 10.

Furthermore, the set of processors 810 may be configured to generate a prompt 500 for an LLM 50, as shown in FIG. 5. The prompt 500 may comprise the input content, the question 40 and a command 51. The command 51 may force the LLM 50 to use the input content for generating a provisional answer 52. According to one example, the processor 810 may generate a respective prompt for the respective question of the set of questions. The respective prompt may be created in a similar manner to the prompt 500 with each repetition of the question loop with the question 40 being the respective question. By that, a respective provisional answer may be produced for the respective question.

In step 105, the set of processors 810 may compare the respective provisional answer and the answer corresponding to that respective question dependent on which the respective prompt is generated in the respective repetition, in the following referred to as respective target answer. The set of processors 810 may compute a respective score for the respective question dependent on a result of the comparison between the respective provisional answer and the respective target answer. For performing the comparison between the respective provisional answer and the respective target answer, the set of processors 810 may generate an embedding vector for the respective target answer and an embedding vector for the respective provisional answer using the same embedding model which is used for generating the embedding vectors 100 and 40.1. Performing the comparison between the respective provisional answer and the respective target answer may comprise computing a respective further similarity score dependent on the embedding vector for respective provisional answer and the embedding vector for respective target answer using the similarity metric selected for the repetitions or another similarity metric. The score for the respective question may be the respective further similarity score.

The set of processors 810 may operate the LLM 50 according to a setting of the values of the sixth parameter 206, the seventh parameter 207, the eighth parameter 208 and/or the ninth parameter 209. According to the example given in FIG. 6, for the first repetition indicated by means of the first row, the value of the sixth parameter 206 may be set equal to 1,000 (number of tokens), the value of the seventh parameter 207 may be set equal to 1.3, the value of the eighth parameter 208 may be set equal to 1 indicating a first type of LLM to be operated as the LLM 50, and/or the value of the ninth parameter 209 may be set equal to 0.9. The first type of LLM may be a GPT-4 model. A second type of LLM may be a BERT model indicated with the value 2 in table 200. A third type of LLM may be a LLAMA model indicated with the value 3 in table 200.

Thus, in one example, the value of the respective parameter may either prescribe how the chunks may be created or how the input content may be created on the basis of the selected chunks or how the LLM 50 is operated for generating the respective provisional answer.

The set of processors 810 may further compute the overall score for the respective repetition based on the scores for the questions, for example on the basis of the further similarity scores. Practically, the overall score for the respective repetition may be equal to the average of the scores for the questions, for example equal to the average of the further similarity scores. According to the example shown in table 200, the overall score for the first repetition may be equal to 0.40. The overall scores for the repetitions are labelled with the reference sign 220.

Table 200 illustrates a setting of the values of the parameters and a respectively obtained overall score for six repetitions. Each repetition may comprise a loop over all questions of the set of questions. Thus, the repetitions may be considered as patterns, the respective pattern representing a different setting of the parameters. A setting of the parameters may be considered as being different if the value of at least one parameter of the parameters is different. The settings may be indicated by numbers given in the first column of table 200. The values of the table 200 may be set manually according to one example. In another example, the values of the table 200 may be obtained by performing a DOE method as described above. The table 200 may be stored in the storage 824 or in the volatile memory 812.

In one example, the prompt 500, in particular the command 51, may comprise instructions to set the values of the sixth parameter 206, the seventh parameter 207, the eighth parameter 208 and/or the ninth parameter 209 according to the respective setting for operating the LLM 50 in the respective repetition.

The set of processors 810 may generate a respective training data set dependent on the values of the parameters of the respective pattern and the overall score obtained for the respective setting. Thus, the respective row of table 200 may represent the respective training data set. It is understood that in most applications for more than 6 setting the overall score may be determined, for example for 100 or up to 1,000 settings.

As an example, for the first setting a first training data set 1 is shown in FIG. 7. Similarly, a second training data set 2 for the second setting (second row of table 200), a third training data set 3 for the third setting (third row), a fourth training data set 4 for the fourth setting (fourth row), a fifth training data set 5 for the fifth setting (fifth row) and a sixth training data set for the sixth setting (sixth row) is depicted in FIG. 7. A ML-module 70 may be considered as an example of the above described ML-module. For example, the ML-module 70 may comprise several decision trees. The set of processors 810 may train the ML-module 70 dependent on the training data sets 1, 2, 3, 4, 5, 6 using one of the above described training methods, for example Random Forest or Gradient Boosted Trees.

The training may comprise using the overall score of the respective training data set as a target output value for the ML-module 70. The set of processors 810 may compute a respective training output value 71 for the respective setting of parameters using the ML-module 70. For that, the set of processors 810 may provide the respective set of values of the parameters for the respective setting as input for the ML-module 70 and receive as a response the respective training output value 71.

Furthermore, set of processors 810 may compute a value of the above described cost or lost function dependent on a deviation of the training output values of the ML-module 70 from the overall scores of the training data sets. The training may further comprise adapting values of parameters of the ML-module 70 dependent on the cost or loss function, for example dependent on partial derivatives of the cost or loss function with respect to the parameters of the ML-module 70. If the value of the cost or lost function has reached a predefined threshold, the training may be aborted and the ML-module 70 may be in a trained state.

Performing the step 109 may involve generating a number of “n” trial sets 80. FIG. 8 depicts schematically a respective trial set 80i and more specifically a first trial set 80₁, a second trial set 80₂ and an n-th trial set 80ₙ. The respective trial set 80i may comprise values of those parameters whose values are modified in the repetitions. The trial sets 80 may have the same dimension as the respective set of values of the parameters whose values are modified in the repetitions. Performing the search for the improved values may comprise providing the respective trial set 80i as input to the trained ML-module 70 and receive in response a respective trail score 81i from the ML-module 70. A result of performing the search may be to identify the improved values as the values of that trial set of the trial sets 80 for which the highest trial score is obtained, in the following referred to as best trial set. The search may be performed according to one of the above described variants, for example may be performed as a grid search or may use one or more genetic algorithms.

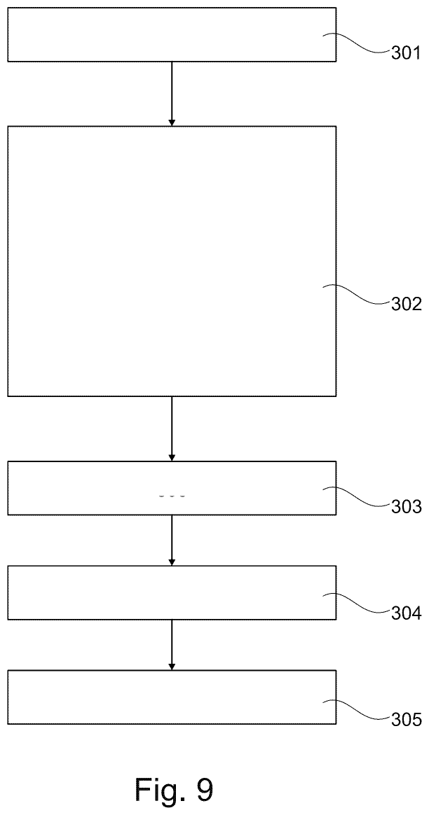

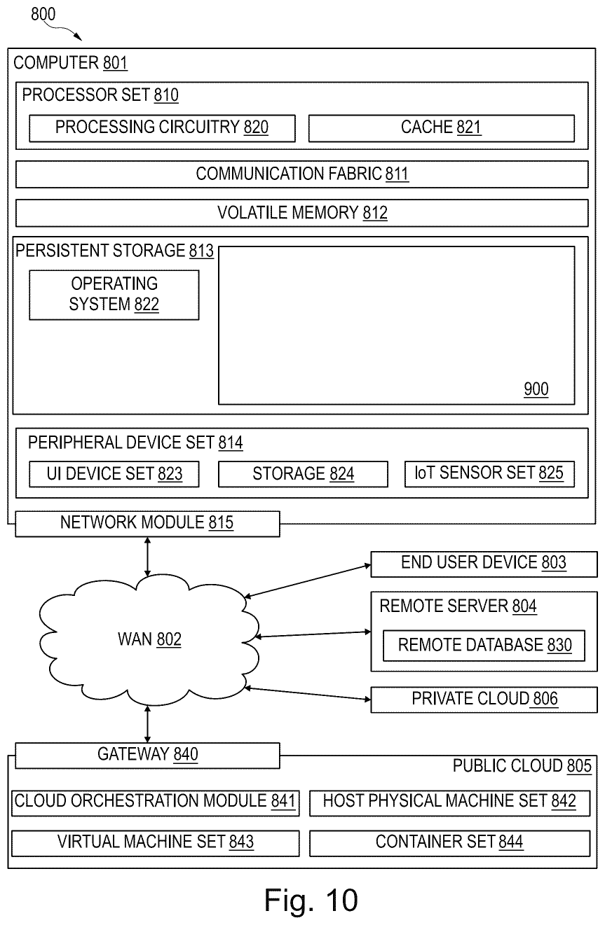

FIG. 9 is a flowchart of an application method for applying the trained ML-module 70. In step 301, a new question related to the set of documents, for example the documents 11, 12 and 13, may be received. In step 302, a new set of chunks of the documents may be generated dependent on the set of documents. In addition, in step 302, a new input content may be generated dependent on the new set of chunks of the documents. The generating of the new set of chunks and the new input content is performed according to a new mode. The new mode is specified by means of the improved set of values of the parameters, i.e. by the values of the parameters given by the best trial set. The respective value of the improved set of values of the parameters may specify how the generating of the new set of chunks or the new input content is performed.

In step 303, a new prompt for the LLM 50 may be generated dependent on the new input content and the new question. The new prompt may be generated analogously to the prompt 500, however the new question may be used instead of the question 40 and the new input content may be used instead of the input content.

In step 304, the new prompt may be provided as a new input to the LLM 50 and a new answer may be received in response from the LLM 50.

In step 305, the new answer may be provided as a response to the new question.

According to one application, computations of the LLM 50 may be performed on a further computing device, for example on a REMOTE SERVER 804 or on a PUBLIC CLOUD 805 shown in FIG. 10. In this case, the prompt 500 may be send from the computer 801 to the further computing device, for example to the REMOTE SERVER 804 or to the PUBLIC CLOUD 805. According to this application, the respective provisional answer for the respective question of the set of questions may be send from the further computing device, for example from the REMOTE SERVER 804 or the PUBLIC CLOUD 805, to the computer 801. By using the trained ML-module 70 for searching for the improved values a data traffic between the computer 801 and the further computing device, such as the REMOTE SERVER 804 or the PUBLIC CLOUD 805, may be reduced. Without the trained ML-module 70 the LLM 50 would have to be used for each trial set. As mentioned above a number of the trial sets 80 may be higher than a number of the training data sets. The training of the ML-module may be performed on the computer 801. As a training of the ML-module 70 may be considered as computationally cheap, the computer 801 may comprise less computational power than the further computing device. Thus, using the ML-module 70 for finding the improved values may allow to use a computing device with comparatively less power.

Computing environment 800 contains an example of an environment for the execution of at least some of the computer code involved in performing the inventive methods, such as code in block 900 for determining the improved set of values of parameters for operating a Large-Language-Model according to one of the above described variants. The computer environment 800 may be one example of the above mentioned computer system. In addition to block 900, computing environment 800 includes, for example, computer 801, wide area network (WAN) 802, end user device (EUD) 803, remote server 804, public cloud 805, and private cloud 806. In this embodiment, computer 801 includes processor set 810 (including processing circuitry 820 and cache 821), communication fabric 811, volatile memory 812, persistent storage 813 (including operating system 822 and block 900, as identified above), peripheral device set 814 (including user interface (UI) device set 823, storage 824, and Internet of Things (IoT) sensor set 825), and network module 815. Remote server 804 includes remote database 830. Public cloud 805 includes gateway 840, cloud orchestration module 841, host physical machine set 842, virtual machine set 843, and container set 844.

COMPUTER 801 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 830. As is well understood in the art of computer technology, and depending upon the technology, performance of a computer-implemented method may be distributed among multiple computers and/or between multiple locations. On the other hand, in this presentation of computing environment 800, detailed discussion is focused on a single computer, specifically computer 801, to keep the presentation as simple as possible. Computer 801 may be located in a cloud, even though it is not shown in a cloud in FIG. 10. On the other hand, computer 801 is not required to be in a cloud except to any extent as may be affirmatively indicated.

PROCESSOR SET 810 includes one, or more, computer processors of any type now known or to be developed in the future. Processing circuitry 820 may be distributed over multiple packages, for example, multiple, coordinated integrated circuit chips. Processing circuitry 820 may implement multiple processor threads and/or multiple processor cores. Cache 821 is memory that is located in the processor chip package(s) and is typically used for data or code that should be available for rapid access by the threads or cores running on processor set 810. Cache memories are typically organized into multiple levels depending upon relative proximity to the processing circuitry. Alternatively, some, or all, of the cache for the processor set may be located “off chip.” In some computing environments, processor set 810 may be designed for working with qubits and performing quantum computing.

Computer readable program instructions are typically loaded onto computer 801 to cause a series of operational steps to be performed by processor set 810 of computer 801 and thereby effect a computer-implemented method, such that the instructions thus executed will instantiate the methods specified in flowcharts and/or narrative descriptions of computer-implemented methods included in this document (collectively referred to as “the inventive methods”), for example a method for determining the improved set of values of parameters for operating a Large-Language-Model according to one of the variants mentioned above. These computer readable program instructions are stored in various types of computer readable storage media, such as cache 821 and the other storage media discussed below. The program instructions, and associated data, are accessed by processor set 810 to control and direct performance of the inventive methods. In computing environment 800, at least some of the instructions for performing the inventive methods may be stored in block 900 in persistent storage 813.

COMMUNICATION FABRIC 811 is the signal conduction path that allows the various components of computer 801 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 812 is any type of volatile memory now known or to be developed in the future. Examples include dynamic type random access memory (RAM) or static type RAM. Typically, volatile memory 812 is characterized by random access, but this is not required unless affirmatively indicated. In computer 801, the volatile memory 812 is located in a single package and is internal to computer 801, but, alternatively or additionally, the volatile memory may be distributed over multiple packages and/or located externally with respect to computer 801.

PERSISTENT STORAGE 813 is any form of non-volatile storage for computers that is now known or to be developed in the future. The non-volatility of this storage means that the stored data is maintained regardless of whether power is being supplied to computer 801 and/or directly to persistent storage 813. Persistent storage 813 may be a read only memory (ROM), but typically at least a portion of the persistent storage allows writing of data, deletion of data and re-writing of data. Some familiar forms of persistent storage include magnetic disks and solid state storage devices. Operating system 822 may take several forms, such as various known proprietary operating systems or open source Portable Operating System Interface-type operating systems that employ a kernel. The code included in block 900 typically includes at least some of the computer code involved in performing the inventive methods.

PERIPHERAL DEVICE SET 814 includes the set of peripheral devices of computer 801. Data communication connections between the peripheral devices and the other components of computer 801 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 823 may include components such as a display screen, speaker, microphone, wearable devices (such as goggles and smart watches), keyboard, mouse, printer, touchpad, game controllers, and haptic devices. Storage 824 is external storage, such as an external hard drive, or insertable storage, such as an SD card. Storage 824 may be persistent and/or volatile. In some embodiments, storage 824 may take the form of a quantum computing storage device for storing data in the form of qubits. In embodiments where computer 801 is required to have a large amount of storage (for example, where computer 801 locally stores and manages a large database) then this storage may be provided by peripheral storage devices designed for storing very large amounts of data, such as a storage area network (SAN) that is shared by multiple, geographically distributed computers. IoT sensor set 825 is made up of sensors that can be used in Internet of Things applications. For example, one sensor may be a thermometer and another sensor may be a motion detector.

NETWORK MODULE 815 is the collection of computer software, hardware, and firmware that allows computer 801 to communicate with other computers through WAN 802. Network module 815 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 815 are performed on the same physical hardware device. In other embodiments (for example, embodiments that utilize software-defined networking (SDN)), the control functions and the forwarding functions of network module 815 are performed on physically separate devices, such that the control functions manage several different network hardware devices. Computer readable program instructions for performing the inventive methods can typically be downloaded to computer 801 from an external computer or external storage device through a network adapter card or network interface included in network module 815.

WAN 802 is any wide area network (for example, the internet) capable of communicating computer data over non-local distances by any technology for communicating computer data, now known or to be developed in the future. In some embodiments, the WAN 802 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 803 is any computer system that is used and controlled by an end user (for example, a customer of an enterprise that operates computer 801), and may take any of the forms discussed above in connection with computer 801. EUD 803 typically receives helpful and useful data from the operations of computer 801. For example, in a hypothetical case where computer 801 is designed to provide a recommendation to an end user, this recommendation would typically be communicated from network module 815 of computer 801 through WAN 802 to EUD 803. In this way, EUD 803 can display, or otherwise present, the recommendation to an end user. In some embodiments, EUD 803 may be a client device, such as thin client, heavy client, mainframe computer, desktop computer and so on.

REMOTE SERVER 804 is any computer system that serves at least some data and/or functionality to computer 801. Remote server 804 may be controlled and used by the same entity that operates computer 801. Remote server 804 represents the machine(s) that collect and store helpful and useful data for use by other computers, such as computer 801. For example, in a hypothetical case where computer 801 is designed and programmed to provide a recommendation based on historical data, then this historical data may be provided to computer 801 from remote database 830 of remote server 804.

PUBLIC CLOUD 805 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 805 is performed by the computer hardware and/or software of cloud orchestration module 841. The computing resources provided by public cloud 805 are typically implemented by virtual computing environments that run on various computers making up the computers of host physical machine set 842, which is the universe of physical computers in and/or available to public cloud 805. The virtual computing environments (VCEs) typically take the form of virtual machines from virtual machine set 843 and/or containers from container set 844. It is understood that these VCEs may be stored as images and may be transferred among and between the various physical machine hosts, either as images or after instantiation of the VCE. Cloud orchestration module 841 manages the transfer and storage of images, deploys new instantiations of VCEs and manages active instantiations of VCE deployments. Gateway 840 is the collection of computer software, hardware, and firmware that allows public cloud 805 to communicate through WAN 802.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 806 is similar to public cloud 805, except that the computing resources are only available for use by a single enterprise. While private cloud 806 is depicted as being in communication with WAN 802, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 805 and private cloud 806 are both part of a larger hybrid cloud.

CLOUD COMPUTING SERVICES AND/OR MICROSERVICES (not separately shown in FIG. 10): private and public clouds are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of application programming interfaces (APIs). One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim.” A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The present subject matter may comprise the following clauses.

Clause 1. A method for determining an improved set of values of parameters for operating a Large-Language-Model, LLM, dependent on a set of documents, the method comprising: loading a set of questions and answers, wherein the respective answer corresponds to one of the questions and the questions relate to a content provided by the set of documents; performing repetitions, the repetitions comprising using a respective mode: generating a respective set of chunks of the documents dependent on the set of documents and an input content dependent on the set of chunks of the documents, wherein the generating of the set of chunks and the input content is performed according to the mode and the mode differs for the respective repetition and is specified by means of a respective set of values of the parameters, the value of the respective parameter specifying how the generating of the set of chunks or the input content is performed; generating a prompt for the LLM dependent on the input content and a question of the questions; providing the prompt as an input to the LLM and receiving a respective provisional answer in response from the LLM; and performing a comparison between the provisional answer and the answer corresponding to that question dependent on which the prompt was generated resulting in a score for the question; the method further comprising: generating a respective overall score for the respective mode dependent on the resulting scores for the questions; generating training data sets comprising for the modes the respective set of values of the parameters specifying the mode and the respective overall score; training a machine-learning (ML) module, ML-module, using the sets of values of the parameters of the training data sets as input and the overall scores of the training data sets as target output of the ML-module; and performing a search for the improved set of values of the parameters using the trained ML-module, wherein inputting the improved set of values of the parameters into the trained ML-module results in an improved score greater than the greatest overall score of the training data sets.

Clause 2. The method of clause 1, the method further comprising: receiving a new question related to the set of documents; generating a new set of chunks of the documents dependent on the set of documents and a new input content dependent on the new set of chunks of the documents, wherein the generating of the new set of chunks and the new input content is performed according to a new mode and the new mode is specified by means of the improved set of values of the parameters, the respective value of the improved set of values of the parameters specifying how the generating of the new set of chunks or the new input content is performed; generating a new prompt for the LLM dependent on the new input content and the new question; providing the new prompt as a new input to the LLM and receiving a new answer in response from the LLM; and providing the new answer as a response to the new question.

Clause 3. The method of clause 1 or 2, wherein the ML-module comprises a decision tree, the training of the ML-module comprising training the decision tree.

Clause 4. The method of clause 3, wherein the ML-module comprises a set of decision trees comprising the decision tree, the training of the ML-module comprising generating proper subsets of the training data sets, wherein the proper subsets are random samples of the training data sets, and training the respective decision tree using the respective subset of the training data sets.

Clause 5. The method of any of the preceding clauses 1 to 4, wherein the performing of the search comprises performing a grid search, a random search or performing the search on the basis of a genetic algorithm.

Clause 6. The method of any of the preceding clauses 1 to 5, wherein the parameters of the set of parameters represent input features of the ML-module, the training of the ML-module comprising determining a feature importance score for the respective input feature, wherein the feature importance score indicates a relative impact of the respective input feature on a prediction of the ML-module.

Clause 7. The method of any of the preceding clauses 1 to 6, the method further comprising for the respective repetition: selecting a chunk size for the chunks of the set of chunks, wherein a value of a parameter of the set of parameters specifies the chunk size.

Clause 8. The method of any of the preceding clauses 1 to 7, the method further comprising for the respective repetition: selecting chunks of the set of chunks and generating the input content dependent on the selected chunks, wherein a value of a parameter of the set of parameters specifies a number of the selected chunks.

Clause 9. The method of any of the preceding clauses 1 to 8, the method further comprising for the respective repetition: selecting a size of common parts of the set of chunks; and performing the generating of the set of chunks such that the respective chunk of the set of chunks comprises at least one common part which is comprised by another chunk of the set of chunks, wherein a value of a parameter of the set of parameters specifies the size of the common parts.

Clause 10. The method of any of the preceding clauses 1 to 9, the method further comprising for the respective repetition: selecting a type of an embedding model for generating a respective embedding vector dependent on the respective chunk of the set of chunks, wherein the respective embedding vector represents the respective chunk, wherein a value of a parameter of the set of parameters specifies the type of the embedding model.

Clause 11. The method of any of the preceding clauses 1 to 10, the method further comprising for the respective repetition: selecting a respective size of embedding vectors, wherein the respective embedding vector represents the respective chunk of the set of chunks, wherein a respective value of a parameter of the set of parameters specifies the respective size of the embedding vectors.

Clause 12. The method of any of the preceding clauses 1 to 11, the method further comprising for the respective repetition: selecting a size of the provisional answer, wherein a value of a parameter of the set of parameters specifies the size of the provisional answer.

Clause 13. The method of any of the preceding clauses 1 to 12, the method further comprising for the respective repetition: selecting a value of a parameter of the set of parameters, wherein the value of the parameter indicates a degree of repetition of similar context in the provisional answer.

Clause 14. The method of any of the preceding clauses 1 to 13, the method further comprising for the respective repetition: selecting a type of the LLM, wherein a value of a parameter of the set of parameters specifies the selected type of the LLM.

Clause 15. The method of any of the preceding clauses 1 to 14, the method further comprising for the respective repetition: selecting a value of a parameter of the set of parameters, wherein the value of the parameter indicates a degree of modification of a probability distribution of the LLM.

Clause 16. The method of any of the preceding clauses 1 to 15, the method further comprising for the respective repetition: selecting a type of retrieval method, the generating of the input content comprising performing the selected retrieval method for obtaining the input content, wherein a value of a parameter of the set of parameters specifies the selected type of retrieval method.

Clause 17. The method of any of the preceding clauses 1 to 16, the method further comprising for the respective repetition: selecting a chunking method from a set of chunking methods for generating chunks dependent on documents and generating the set of chunks according to the selected chunking method, wherein a value of a parameter of the set of parameters specifies the selected chunking method.

Clause 18. The method of any of the preceding clauses 1 to 17, the method further comprising for the respective repetition: generating embedding vectors, wherein the respective embedding vector represents the respective chunk of the set of chunks; generating a further embedding vector which represents the question or a set of further embedding vectors which represent the question; selecting a type of similarity metric, wherein a value of a parameter of the set of parameters specifies the selected type of similarity metric; performing a comparison between the embedding vectors and the further embedding vector using the selected similarity metric or a comparison between the embedding vectors and the set of further embedding vectors using the selected similarity metric; selecting a subset of the chunks dependent on a result of the comparison; and generating the input content dependent on the selected subset of the chunks.

Clause 19. The method of any of the preceding clauses 1 to 18, the method further comprising for the respective repetition: performing a selection of a value of a parameter of an embedding model for generating a respective embedding vector dependent on the respective chunk of the set of chunks, wherein the respective embedding vector represents the respective chunk, wherein a value of a parameter of the set of parameters specifies the value of the parameter of the embedding model.

Clause 20. A computer program product comprising a computer-readable storage medium having computer-readable program code embodied therewith, the computer-readable program code configured to implement the method of any of the preceding clauses 1 to 19.

Clause 21. A computer system for determining an improved set of values of parameters for generating an improved prompt for a Large-Language-Model, LLM, dependent on a set of documents, wherein the computer system is configured to: load a set of questions and answers, wherein the respective answer corresponds to one of the questions and the questions relate to a content provided by the set of documents; perform repetitions, the repetitions comprising using a respective mode: generating a respective set of chunks of the documents dependent on the set of documents and an input content dependent on the set of chunks of the documents, wherein the generating of the set of chunks and the input content is performed according to the mode and the mode differs for the respective repetition and is specified by means of a respective set of values of the parameters, the value of the respective parameter specifying how the generating of the set of chunks or the input content is performed; generating a prompt for the LLM dependent on the input content and a question of the questions; providing the prompt as an input to the LLM and receiving a respective provisional answer in response from the LLM; and performing a comparison between the provisional answer and the answer corresponding to that question dependent on which the prompt was generated resulting in a score for the question; the computer system further being configured to: generate a respective overall score for the respective mode dependent on the resulting scores for the questions; generate training data sets comprising for the modes the respective set of values of the parameters specifying the mode and the respective overall score; train a machine-learning module, ML-module, using the sets of values of the parameters of the training data sets as input and the overall scores of the training data sets as target output of the ML-module; and perform a search for the improved set of values of the parameters using the trained ML-module, wherein inputting the improved set of values of the parameters into the trained ML-module results in an improved score greater than the greatest overall score of the training data sets.

Clause 22. The computer system of clause 21, the computer system being further configured to: receive a new question related to the set of documents; generate a new set of chunks of the documents dependent on the set of documents and a new input content dependent on the new set of chunks of the documents, wherein the generating of the new set of chunks and the new input content is performed according to a new mode and the new mode is specified by means of the improved set of values of the parameters, the respective value of the improved set of values of the parameters specifying how the generating of the new set of chunks or the new input content is performed; generate a new prompt for the LLM dependent on the new input content and the new question; provide the new prompt as a new input to the LLM and receive a new answer in response from the LLM; and provide the new answer as a response to the new question.

Clause 23. The computer system of clause 21 or 22, wherein the ML-module comprises a set of decision trees, the training of the ML-module comprising generating proper subsets of the training data sets, wherein the proper subsets are random samples of the training data sets, and training the respective decision tree using the respective subset of the training data sets.

What is claimed is:

1. A method for determining an improved set of values of parameters for operating a Large-Language-Model, LLM, dependent on a set of documents, the method comprising:
loading a set of questions and answers, wherein a respective answer corresponds to one of the questions and the questions relate to a content provided by the set of documents;
performing repetitions, the repetitions comprising using a respective mode:
generating a respective set of chunks of the documents dependent on the set of documents and an input content dependent on the set of chunks of the documents, wherein the generating of the set of chunks and the input content is performed according to the respective mode and the respective mode differs for a respective repetition and is specified by a respective set of values of the parameters, a value of a respective parameter specifying how the generating of the set of chunks or the input content is performed;
generating a prompt for the LLM dependent on the input content and a question of the questions;
providing the prompt as an input to the LLM and receiving a respective provisional answer in response from the LLM; and
performing a comparison between the respective provisional answer and the respective answer corresponding to that question dependent on the prompt that was generated, resulting in a score for the question;
the method further comprising:
generating a respective overall score for the respective mode dependent on the resulting scores for the questions;
generating training data sets comprising for the modes the respective set of values of the parameters specifying the respective mode and the respective overall score;
training a machine-learning module, ML-module, using the sets of values of the parameters of the training data sets as input and the overall scores of the training data sets as target output of the ML-module; and
performing a search for the improved set of values of the parameters using the trained ML-module, wherein inputting the improved set of values of the parameters into the trained ML-module results in an improved score greater than a greatest overall score of the training data sets.

2. The method of claim 1, the method further comprising:
receiving a new question related to the set of documents;
generating a new set of chunks of the documents dependent on the set of documents and a new input content dependent on the new set of chunks of the documents, wherein the generating of the new set of chunks and the new input content is performed according to a new mode, and the new mode is specified by the improved set of values of the parameters, the respective value of the improved set of values of the parameters specifying how the generating of the new set of chunks or the new input content is performed;
generating a new prompt for the LLM dependent on the new input content and the new question;
providing the new prompt as a new input to the LLM and receiving a new answer in response from the LLM; and
providing the new answer as a response to the new question.

3. The method of claim 1, wherein the ML-module comprises a decision tree, the training of the ML-module comprising training the decision tree.

4. The method of claim 3, wherein the ML-module comprises a set of decision trees comprising the decision tree, the training of the ML-module comprising generating proper subsets of the training data sets, wherein the proper subsets are random samples of the training data sets, and training the respective decision tree using the respective subset of the training data sets.

5. The method of claim 1, wherein the performing of the search comprises performing a grid search, a random search, or performing the search based on a genetic algorithm.

6. The method of claim 1, wherein the parameters of the set of parameters represent input features of the ML-module, the training of the ML-module comprising determining a feature importance score for a respective input feature, wherein a feature importance score indicates a relative impact of the respective input feature on a prediction of the ML-module.

7. The method of claim 1, the method further comprising for the respective repetition:
selecting a chunk size for the chunks of the set of chunks, wherein a value of a parameter of the set of parameters specifies the chunk size.

8. The method of claim 1, the method further comprising for the respective repetition:
selecting chunks of the set of chunks and generating the input content dependent on the selected chunks, wherein a value of a parameter of the set of parameters specifies a number of the selected chunks.

9. The method of claim 1, the method further comprising for the respective repetition:
selecting a size of common parts of the set of chunks; and
performing the generating of the set of chunks such that the respective chunk of the set of chunks comprises at least one common part, which is comprised by another chunk of the set of chunks, wherein a value of a parameter of the set of parameters specifies the size of the at least one common part.

10. The method of claim 1, the method further comprising for the respective repetition:
selecting a type of an embedding model for generating a respective embedding vector dependent on the respective chunk of the set of chunks, wherein the respective embedding vector represents the respective chunk, wherein a value of a parameter of the set of parameters specifies the type of the embedding model.

11. The method of claim 1, the method further comprising for the respective repetition:
selecting a respective size of embedding vectors, wherein a respective embedding vector represents the respective chunk of the set of chunks, and wherein a respective value of a parameter of the set of parameters specifies the respective size of the embedding vectors.

12. The method of claim 1, the method further comprising for the respective repetition:
selecting a size of the provisional answer, wherein a value of a parameter of the set of parameters specifies the size of the provisional answer.

13. The method of claim 1, the method further comprising for the respective repetition:
selecting a value of a parameter of the set of parameters, wherein the value of the parameter indicates a degree of repetition of similar context in the provisional answer.

14. The method of claim 1, the method further comprising for the respective repetition:
selecting a type of the LLM, wherein a value of a parameter of the set of parameters specifies the selected type of the LLM.

15. The method of claim 1, the method further comprising for the respective repetition:
selecting a value of a parameter of the set of parameters, wherein the value of the parameter indicates a degree of modification of a probability distribution of the LLM.

16. The method of claim 1, the method further comprising for the respective repetition:
selecting a type of retrieval method, the generating of the input content comprising performing the retrieval method for obtaining the input content, wherein a value of a parameter of the set of parameters specifies the selected type of retrieval method.

17. The method of claim 1, the method further comprising for the respective repetition:
selecting a chunking method from a set of chunking methods for generating chunks dependent on documents and generating the set of chunks according to the selected chunking method, wherein a value of a parameter of the set of parameters specifies the selected chunking method.

18. The method of claim 1, the method further comprising for the respective repetition:
generating embedding vectors, wherein the respective embedding vector represents the respective chunk of the set of chunks;
generating a further embedding vector which represents the question or a set of further embedding vectors which represent the question;
selecting a type of similarity metric, wherein a value of a parameter of the set of parameters specifies the selected type of similarity metric;
performing a comparison between the embedding vectors and the further embedding vector using the similarity metric or a comparison between the embedding vectors and the set of further embedding vectors using the similarity metric;
selecting a subset of the chunks dependent on a result of the comparison; and
generating the input content dependent on the selected subset of the chunks.

19. The method of claim 1, the method further comprising for the respective repetition:
performing a selection of a value of a parameter of an embedding model for generating a respective embedding vector dependent on the respective chunk of the set of chunks, wherein the respective embedding vector represents the respective chunk, wherein a value of a parameter of the set of parameters specifies the value of the parameter of the embedding model.

20. A computer program product comprising a computer-readable storage medium having computer-readable program code embodied therewith, the computer-readable program code configured to implement operations for determining an improved set of values of parameters for operating a Large-Language-Model, LLM, dependent on a set of documents comprising:
loading a set of questions and answers, wherein a respective answer corresponds to one of the questions and the questions relate to a content provided by the set of documents;
performing repetitions, the repetitions comprising using a respective mode:
generating a respective set of chunks of the documents dependent on the set of documents and an input content dependent on the set of chunks of the documents, wherein the generating of the set of chunks and the input content is performed according to the respective mode and the respective mode differs for a respective repetition and is specified by a respective set of values of the parameters, a value of a respective parameter specifying how the generating of the set of chunks or the input content is performed;
generating a prompt for the LLM dependent on the input content and a question of the questions;
providing the prompt as an input to the LLM and receiving a respective provisional answer in response from the LLM; and
performing a comparison between the respective provisional answer and the respective answer corresponding to that question dependent on the prompt that was generated, resulting in a score for the question;
the operations further comprising:
generating a respective overall score for the respective mode dependent on the resulting scores for the questions;
generating training data sets comprising for the modes the respective set of values of the parameters specifying the respective mode and the respective overall score;
training a machine-learning module, ML-module, using the sets of values of the parameters of the training data sets as input and the overall scores of the training data sets as target output of the ML-module; and
performing a search for the improved set of values of the parameters using the trained ML-module, wherein inputting the improved set of values of the parameters into the trained ML-module results in an improved score greater than a greatest overall score of the training data sets.

21. A computer system for determining an improved set of values of parameters for generating an improved prompt for a Large-Language-Model, LLM, dependent on a set of documents, comprising:
a processor set;
a computer-readable storage media; and
program instructions stored on the computer-readable storage media to cause the processor set to perform operations comprising:
loading a set of questions and answers, wherein a respective answer corresponds to one of the questions and the questions relate to a content provided by the set of documents;
performing repetitions, the repetitions comprising using a respective mode:
generating a respective set of chunks of the documents dependent on the set of documents and an input content dependent on the set of chunks of the documents, wherein the generating of the set of chunks and the input content is performed according to the respective mode and the respective mode differs for a respective repetition and is specified by a respective set of values of the parameters, a value of a respective parameter specifying how the generating of the set of chunks or the input content is performed;
generating a prompt for the LLM dependent on the input content and a question of the questions;
providing the prompt as an input to the LLM and receiving a respective provisional answer in response from the LLM; and
performing a comparison between the respective provisional answer and the respective answer corresponding to that question dependent on the prompt that was generated resulting in a score for the question;
the operations further comprising:
generating a respective overall score for the respective mode dependent on the resulting scores for the questions;
generating training data sets comprising for the modes the respective set of values of the parameters specifying the respective mode and the respective overall score;
training a machine-learning module, ML-module, using the sets of values of the parameters of the training data sets as input and the overall scores of the training data sets as target output of the ML-module; and
performing a search for the improved set of values of the parameters using the trained ML-module, wherein inputting the improved set of values of the parameters into the trained ML-module results in an improved score greater than a greatest overall score of the training data sets.
